(19) United States
(12) Patent Application Publication
(10) Pub. No.: US 2013/0298021 A1
(43) Pub. Date: Nov. 7, 2013

(54) METHOD OF EXPANSIVELY SEARCHING MULTIMEDIA AND MULTIMEDIA EXECUTING APPARATUS THEREFOR

(71) Applicant: SAMSUNG ELECTRONICS CO., LTD., Gyeonggi-do (KR)

(72) Inventors: Jung-Yong PARK, Gyeongsangbuk-do (KR); Jung-Min YOON, Gyeongsangbuk-do (KR); Sang-Uk LEE, Gyeongsangbuk-do (KR)

(73) Assignee: SAMSUNG ELECTRONICS CO., LTD., Gyeonggi-do (KR)

(21) Appl. No.: 13/792,701

(22) Filed: Mar. 11, 2013

(30) Foreign Application Priority Data
May 2, 2012 (KR) 10-2012-0046167

(51) Int. Cl. G06F 3/0484

(52) U.S. Cl. CPC G06F 3/04847
USPC 715/716

(57) ABSTRACT

A method and an apparatus are disclosed for moving an execution point of a multimedia file through an expansive search of a multimedia file being executed by the multimedia executing apparatus. When the multimedia executing apparatus enters into an expansive search mode during a display of a progress bar having an execution point for execution of a multimedia file on a screen according to the execution of the multimedia file, an enlarged progress bar representing an enlarged section of the progress bar including the execution point is displayed on the screen.

### CLAIM OF PRIORITY

This application claims priority under 35 U.S.C. §119(a) to a Korean Patent Application entitled “Method of Expansively Searching Multimedia and Multimedia Reproducing Apparatus Therefore” filed in the Korean Intellectual Property Office on May 2, 2012 and assigned Serial No. 10-2012-0046167, the contents of which are incorporated herein by reference.

### BACKGROUND OF THE INVENTION

1. Field of the Invention

The present invention relates to a method and an apparatus for executing a multimedia file, and more particularly to a method and an apparatus for searching sections of a multimedia file being executed.

2. Description of the Related Art

Devices or apparatus that execute or play multimedia files typically have a file searching function that allows users of such devices to play desired portions of a file or play the entire file.

A multimedia file may contain different types of information such as video, audio, graphical, text or any combination thereof The phrases “execute a multimedia file” or “play a multimedia file” and their variations will hereinafter be used interchangeably. These devices usually include a display screen (or “display”) for displaying the contents of the multimedia file while it is being executed. The file searching function is often implemented with a progress bar displayed at the bottom of the display screen. The progress bar has a start point, an end point and an execution point. As the file is being shown, the execution point (located somewhere between the start and end points) moves towards the end point at a certain rate. Associated with these points are time indications representing the actual times at which a particular content of the multimedia file is being shown; such a time indication is continually changing as the execution point moves towards the end point. With these time indications, the user can determine the amount of time elapsed from the start point to the execution point, the amount of time remaining for the execution point to reach the end point and the amount of time that will have elapsed when the execution point has reached the end point.

Devices have User Interfaces (UI) that allow users to manipulate the location of the execution point along the progress bar when searching through the multimedia file. In particular, a user can move the execution point in the forward direction (i.e., towards the end point) or the backward direction (i.e., towards the start point). With the advent of wireless technology, the use of a progress bar to search through a multimedia file has now migrated to mobile devices. For example, such mobile devices as tablet computers, smart phones, MP3 (MPEG-1 Audio Player-3) players, Portable Multimedia Players (PMP) and digital cameras are also used as multimedia playing devices. These mobile devices have now come to use touch screens as a User Interface.

A touch screen displays graphics and texts on the screen where such screen detects and responds to a user contact. A device employing a touch screen may display one or more soft keys, menus, and other user interface objects displayed on the touch screen. A user may make an input related to a user interface object by making contact with the screen at a location on the screen corresponding to the position of the user interface object.

When a mobile device employing the touch screen displays a progress bar, a user may move the execution point by making contact with the progress bar. The contact with the progress bar may include a touch and a drag by the user. To move the execution point of the progress bar, a user may drag the execution point in a forward or backward direction; the user may also touch a point on the progress bar that is ahead of the execution point or behind the execution point the achieve the same effect.

The entire length of a progress bar displayed by a multimedia player for a certain file is generally the same for other totally different multimedia files having different total play times. The total play time is the total amount of time it takes to play an entire multimedia file. Accordingly, depending on the size of a multimedia file, a unit length of the progress bar corresponds to a different time period for different files.

Accordingly, when the total play time of a multimedia file is relatively short (say, for example, several seconds), it is not difficult for a user to move an execution point of a progress bar to a desired position on the progress bar; this is because in this case, the unit length of the progress is relatively long and thus it is easier for a user to navigate along the progress in searching through the file. However, when the total play time of a multimedia file is relatively long, it is difficult for a user search the multimedia file through the use of the progress bar because, for this case, the unit length of the progress bar may be impractically small making it difficult to search small portions of the multimedia file. Furthermore, the problem of having difficulty searching a multimedia file is exacerbated when the progress bar is used in mobile devices, which have physically smaller displays. In such cases the actual size of the progress bar is relatively smaller and thus the unit length of such a progress bar may make it impossible to accurately search through a relatively large multimedia file.

### SUMMARY OF THE INVENTION

The present invention provides a method of expansively searching a multimedia file being played on a multimedia executing apparatus or device, which enables a user to conveniently move an execution point of the multimedia file by a desired amount.

Also, the present invention provides a method of expansively searching a multimedia file being executed and a multimedia executing apparatus or device, which may improve the accuracy in the movement of an execution point of a progress bar for the multimedia file.

Further, the present invention provides a method of expansively searching a multimedia file and a multimedia playing apparatus or device, which enables a user to move with relative ease, an execution point of a progress bar for a multimedia file by a short section.

In accordance with an aspect of the present invention, there is provided a method of expansively searching a multimedia file in a multimedia executing apparatus or device, the method including: displaying a progress bar indicating an execution point for execution of a multimedia file on a screen; and displaying an enlarged progress bar comprising an enlarged section of the progress bar including the execution point on the screen when the multimedia executing apparatus or device is caused to enter into an expansive search mode.

In accordance with another aspect of the present invention, there is provided a multimedia executing apparatus including: a touch screen for displaying a progress bar having an execution point for indicating the playing of a particular part of a multimedia file; and a controller for displaying an enlarged progress bar representing an enlarged section of the progress bar including its execution point when the multimedia executing apparatus or apparatus enters into an expansive search mode.

### BRIEF DESCRIPTION OF THE DRAWINGS

FIG. 1 is a block diagram illustrating a multimedia executing apparatus according to an embodiment of the apparatus or device of the present invention.

FIG. 2 is a flowchart illustrating a process of multimedia execution according to an embodiment of the method of the present invention.

FIG. 3 is a flowchart illustrating a process of an expansive search mode according to an embodiment of the method of the present invention.

FIG. 4 is a view illustrating an example of a display of a conventional progress bar.

FIGS. 5A, 5B and 5C are views illustrating examples of a media player screen related to an expansive search according to an embodiment of the present invention.

FIG. 6 is a view illustrating an example of a display of an enlarged progress bar according to another embodiment of the present invention.

### DETAILED DESCRIPTION

Hereinafter, the exemplary embodiments of the present invention will be described with reference to the accompanying drawings. In the following description, the same elements will be designated by the same reference numerals even when they are shown in different drawings. In the following description, a detailed explanation of known related functions and constitutions may be omitted to avoid unnecessarily obscuring the subject matter of the present invention. The description with reference numbers of the accompanying drawings are provided to assist in the general understanding of certain embodiments of the claimed invention. Further, several specific implementations are included for helping to understand the present invention, and in no way limit the claimed invention as recited in the attached claims Accordingly, it will be understood by those skilled in the art that various changes and modifications of the embodiment to be described may be made therein without departing from the spirit and scope of the claimed invention as recited in the appended claims Further, detailed explanations of known related functions and constitutions may be omitted for accuracy and simplicity of description of embodiments of the claimed invention.

Terms and words used in the description and the claims are not necessarily limited to their definitions, and are used by an inventor for accurate and unified understanding of the present invention. Accordingly, a term or a word will be defined based on general contents of the present specification.

Hereinafter, the embodiments of the present invention will be described using on a mobile device as an example, but is certainly not limited to such a mobile device; the embodiments described herein of the present invention may thus be applied to other devices capable of executing multimedia files. Further, other devices may be modified by those skilled in the art to which the claimed invention belongs so that operation and structure of the modified device may fall within the claim language of the present invention. That is, any device or apparatus such as a smart television, a desktop computer, or a laptop computer can be modified to operate in accordance with the claimed invention.

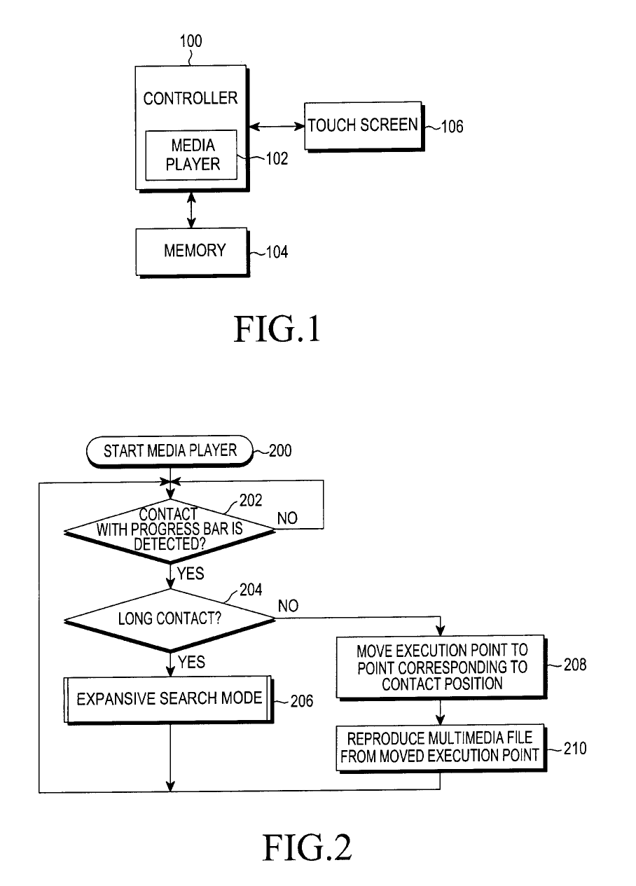

FIG. 1 is a block diagram illustrating a multimedia executing apparatus according to an embodiment of the present invention. In FIG. 1, other elements except for elements directly related to the execution of multimedia files by a mobile device to which the present invention is applied are omitted.

Referring to FIG. 1, a controller 100 includes a media player 102. The media player 102 may be stored in a memory 104 as a software module, and is executed by the controller 100 to execute a multimedia file. The media player 102 may be stored in an internal memory (not shown) of the controller 100 and executed by the controller 100. Conventionally, the media player 102 of a mobile device is implemented with a software module, but may be implemented as a hardware that is not part of the controller 100 and such hardware is coupled to or is in communication with the controller 100.

The memory 104 stores a program for an operation of the controller 100 and stores various data for particular executions of operations of the controller 100. The memory 104 may further include an external memory and a storage device, such as a Hard Disk Drive (HDD).

A display represented by touch screen 106 provides an input/output (I/O) interface and thus serves as a UI between the controller 100 and the user. The touch screen 106 displays an image according to an operation of the controller 100 and provides the controller 100 with a user input according to the location on the touch screen with which the user makes contact. The mobile device may further include other input means, such as a keypad or a hardware button, other than the touch screen 106.

When the controller 100 starts the media player 102, the controller 100 displays a media player screen through the use of touch screen 106. The controller 100 executes (i.e., plays) a multimedia file through the media player 102. The multimedia file may be stored in the memory 104 and may be a streaming file which the mobile device receives from an external source via the Internet or from a network such as a mobile communication network.

The controller 100 displays a progress bar on the media player screen. When a long contact with the progress bar is detected in this state, the controller 100 causes the media player 102 to enter into and operate in an expansive search mode. When the media player is caused to enter the expansive search mode by controller 100, the controller 100 displays on the media player screen an enlarged progress bar, which may represent an enlarged section of the progress bar including its execution point.

When the controller 100 detects a user contact with the enlarged progress bar, the controller 100 moves the execution point to the location corresponding to the contact point location on the enlarged progress bar resulting in a new execution point. In this case, the controller 100 moves the execution point to its new position creating an interval between the new execution point position and the previous execution point position. This interval is actually a reduced time interval. As will be described infra, the interval is reduced according to an enlargement ratio between the progress bar and the enlarged progress bar respectively. The controller 100 then executes the multimedia file from the new execution point.

FIG. 2 is a flowchart illustrating a process of multimedia file execution according to an embodiment of the present invention. Referring to FIG. 2, when the controller 100 starts the media player 102 in step 200, the controller 100 displays the media player screen through the touch screen 106 and displays the progress bar on the media player screen in a conventional manner.

FIG. 4 is a view illustrating an example of a display of a conventional progress bar. Referring to FIG. 4, the progress bar 402 is displayed on the media player screen 400. The progress bar 402 displays a situation in which an entire multimedia file is being executed. FIG. 4 illustrates an example in which the total play time of the multimedia file being executed is 30 minutes 00 seconds and a time of 8 minutes and 8 seconds has elapsed from the start point of the progress bar to the execution point. Further, the execution point of the progress bar 402 is indicated by execution point icon 404 in FIG. 4. There may be a conventional case in which the execution point is indicated only in a form of a progression bar gradually becoming longer according to the passage of execution time corresponding to the movement of the execution point.

In a situation as depicted by FIG. 4 where the progress bar 402 is displayed as shown, the user may move the execution point by contacting the progress bar 402. The contact with the progress bar 402 may include a touch and a drag by the user. The user thus moves the execution point by dragging the execution point icon 404 of the progress bar 402 in a forward or backward or by touching a front or back position (with respect to the execution point) on the progress bar.

When the user desires to use the expansive search function according to the present invention, the user may make a long contact with the progress bar 402. The long contact is a touch not a drag, and is defined by a situation where a user's contact with the progress bar is maintained for at least a predetermined reference time period, which is longer than the length of time of a touch used to effectuate the movement of the execution point. In order to enable the controller 100 to determine whether the contact is the long contact, the reference time period is to be sufficiently long such that the controller 100 is able to discriminate between a touch used for the movement of the execution point and the long contact used to activate the use of the expansive search function. For example, a reference time longer than one second may be set in advance.

Referring back to FIG. 2, when a contact with the progress bar by way of the touch screen 106 is detected in step 202 after the start of the media player in step 200, the controller 100 determines whether the contact is the long contact by comparing in step 204, the contact time with the reference time. When the contact time is equal to or longer than the reference time, the controller 100 causes the media player to enter into the expansive search mode and performs the expansive search function in step 206. However, when the contact time is shorter than the reference time, the controller 100 proceeds to step 208. In step 208, the controller 100 moves the execution point to a point corresponding to the position of the contact. When a user drags the execution point icon 404 in a forward or backward direction, the point corresponding to the contact is a point corresponding to a position to which the execution point icon 404 is dragged. When the user touches a front or back point of the execution point, the point corresponding to the contact is a point corresponding to the touched position. In step 210, the controller 100 starts the execution of the multimedia file from the execution point and then returns to step 202.

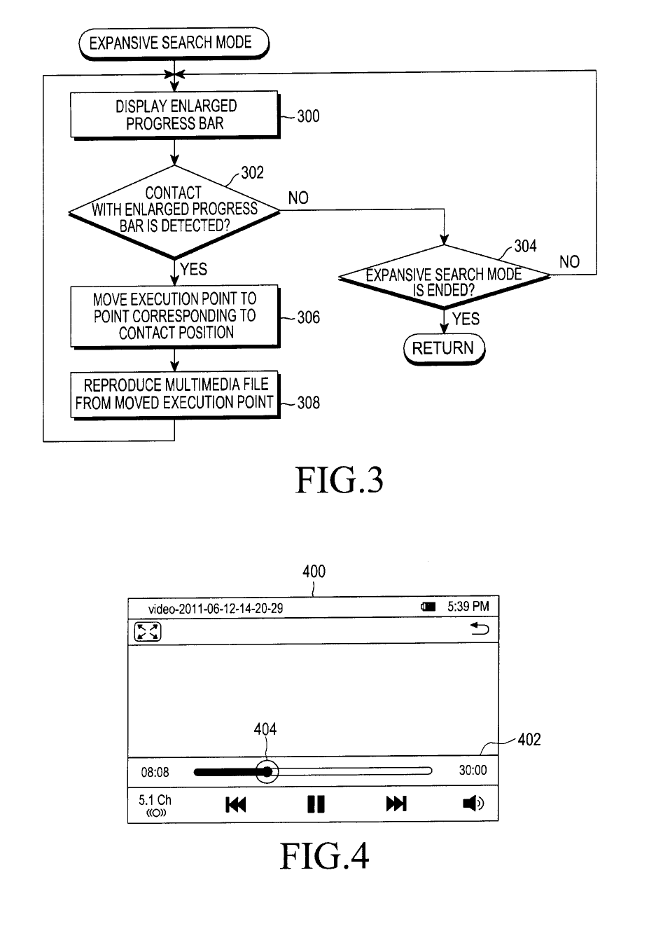

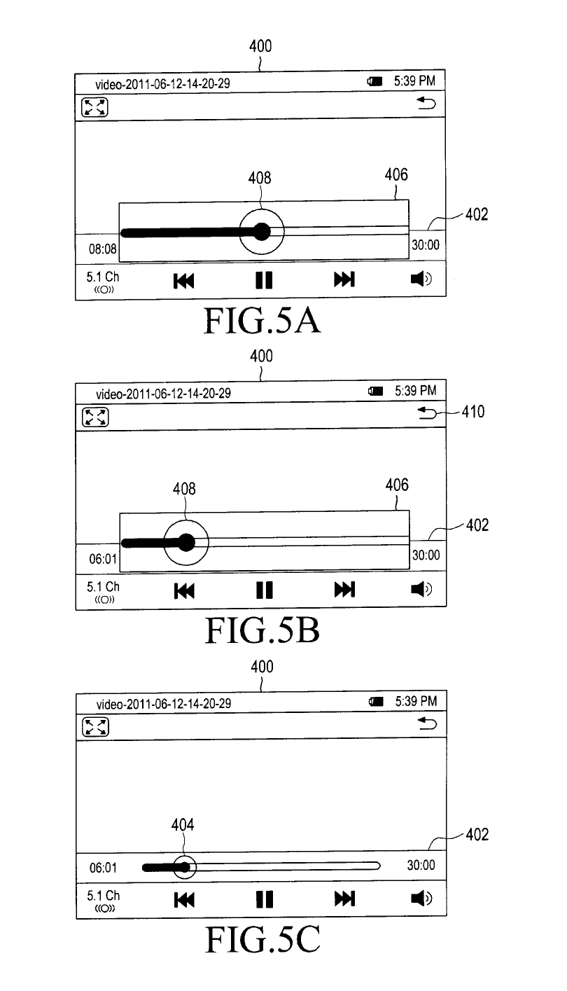

FIG. 3 is a flowchart illustrating a process of the expansive search mode according to an embodiment of the present invention, and in particular, illustrates a flowchart of a detailed process of the expansive search mode in step 206 of FIG. 2. FIGS. 5A to 5C illustrate examples of the media player screen related to the expansive search mode according to the embodiment of the present invention. FIG. 5A illustrates an example of an enlarged progress bar display before the execution point is moved according to an embodiment of the present invention. FIG. 5B illustrates an example of an enlarged progress bar display after the execution point has been moved according to one embodiment of the present invention. FIG. 5C is a view illustrating an example of a progress bar display after the movement of the execution point according to an embodiment of the present invention.

Referring to FIG. 3 and FIGS. 5A to 5C, when the media player is caused to enter the expansive search mode, the controller 100 displays, on screen 400 of a multimedia file executing device, an enlarged progress bar 406 representing an enlarged section of the progress bar 402 having the execution point 408 as illustrated in FIG. 5A and described in step 300 of FIG. 3 respectively. FIG. 5A illustrates an example of the display of the enlarged progress bar 406 partially overlapping the progress bar 402. Because the enlarged progress bar 406 is displayed while partially overlapping the progress bar 402, the user may easily recognize that the expansive search function is being used.

A particular length of the enlarged section of the progress bar 402 in the actual application of the present invention may be set as a default or set by selecting one among different lengths in stages by the user. Similarly, an enlargement ratio of the enlarged progress bar 406 may be set as a default or set by selecting one among different enlargement ratios in stages by the user. Alternatively, the length of the enlarged section of the progress bar 402 and the enlargement ratio of the enlarged progress bar 406 may be designated by the user by directly inputting these desired values. The execution point of the enlarged progress bar 406 is indicated by execution point icon 408, and may also be indicated in an arrangement where a progress bar gradually becomes longer in relation to the passage of the execution time of a multimedia file.

During the display of the enlarged progress bar 406 shown in FIG. 5A, the user may move the execution point by making contact with the enlarged progress bar 406. Contact with the enlarged progress bar 406 may be, for example, a touch and a drag by the user. The user may thus change a portion of the execution time elapsed from the start of the enlarged progress bar to its execution point by dragging the execution point icon 408 of the enlarged progress bar 406 in a forward or backward direction or by touching a front or back point on the enlarged progress bar 406 relative to the position of the execution point.

The enlarged progress bar 406 is an enlarged section of the progress bar 402 and a certain length of the enlarged progress bar 406 corresponds to a shorter time than the same length of the progress bar 402. In other words, physically equal lengths or sections of the progress bar 402 and enlarged progress bar 406 represent different time spans so that the actual time span being represented by enlarged progress bar 406 is shorter than the time span being represented by progress bar 402. Accordingly, in the enlarged progress bar 406 for the same execution time, a length indicating a unit execution time is expanded, resulting in the enlarged progress bar 406 displaying a more segmentized execution time. Accordingly, when the user moves the execution point of the enlarged progress bar 406 by the same distance as the execution point of the progress 402 bar is moved, the distance moved by the execution point of the enlarged progress bar represents a shorter time span compared to the movement of the execution point of the progress bar 402. Therefore, the user may more precisely move the execution point of the enlarged progress bar 406 and may more easily move the execution point of progress bar 406 by a relatively short section, compared to the progress bar 402.

When the enlarged progress bar 406 is displayed as described by step 300, the controller 100 performs steps 302 and 304 when a user makes physical contact with the enlarged progress bar 406 being displayed. In particular, when the controller 100 detects a user making contact with the enlarged progress bar 406 in step 302, it proceeds to step 306. In step 306, the controller 100 moves the execution point to a location corresponding to where the user made contact with the enlarged progress bar 406. In step 308, the controller 100 starts the execution of the multimedia file from the new position of the execution point show in FIG. 5B and then moves to step 300. In the case illustrated by FIGS. 5A and 5B, the controller 100 moves the execution point by a certain interval represented by the distance between the location of the execution point at the time contact is made and the new location of the execution point resulting from the made contact. Such a time interval for the enlarged progress bar is represented by a reduced time interval of the progress bar; the reduction factor is directly based on the enlargement ratio between the progress bar 402 and the enlarged progress bar 406. That is, when the user moves the execution point on the enlarged progress bar 406 by the same distance as that moved on the progress bar 402, the controller 100 has actually moved (i.e., reposition) the execution point of the enlarged progress bar by a shorter time span compared to the movement on the progress bar 402. In the example being illustrated by FIGS. 5A and 5B, when the execution point 408 of enlarged progress bar 406 is moved in a backward direction, the display of the enlarged progress bar 406 is changed as shown in FIG. 5B. The distance between the execution point 408 position in FIG. 5A and execution point 408 position in FIG. 5B of the enlarged progress bar 406 represents a certain physical length X corresponding to a time interval having a time span of Y time units. For the sake of this example, say the enlargement ratio between the progress bar 402 and the enlarged progress bar 406 is 1:2; that is for every one unit of length of progress bar 402, two units of length of enlarged progress bar 406 is displayed. The repositioning of the execution point 404 of the progress bar 402 of FIG. 5C by the same distance X would therefore represent a time span of 2*Y units, which is a more dense time line.

When the expansive search mode is ended in step 304, the controller 100 returns to aforementioned step 202 of FIG. 2. Accordingly, the media player screen 400 is changed to FIG. 5C and the enlarged progress bar 406 disappears. The execution point of the progress bar 402 illustrated in FIG. 5C corresponds to the moved execution point of FIG. 5B. The expansive search mode may be terminated in several ways. For example, when the user touches a “CANCEL” button 410 illustrated in FIG. 5B, the expansive search mode may be terminated. Another example is when a predetermined time passes after the media player enters the expansive search mode, the expansive search mode may be terminated.

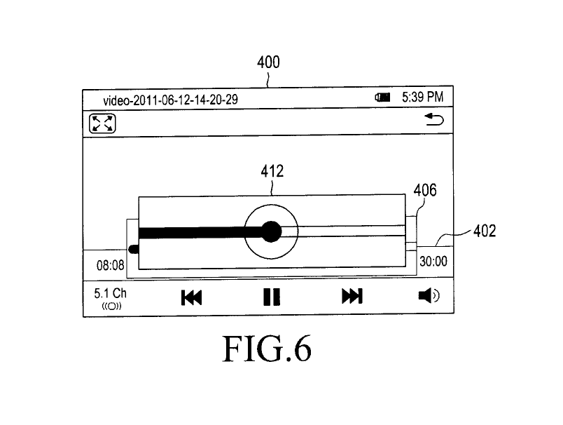

During the expansive search mode, a section of the enlarged progress bar 406 including the execution point may be further enlarged and used to perform an even more detailed search of the multimedia file being executed. FIG. 6 is a view illustrating a display of the enlarged progress bar 412 enlarging a section of enlarged progress bar 406 according to another embodiment of the present invention. When a long contact with the enlarged progress bar 406 is detected by the controller during the display of the enlarged progress bar 406 as illustrated in FIG. 5B, the controller 100 enlarges a partial section of the enlarged progress bar 406 including the execution point resulting in the display of enlarged progress bar 412 as illustrated in FIG. 6. The enlarged progress bar 412 is displayed by partially overlapping on the enlarged progress bar 406. The user may then more precisely move the execution point along the enlarged progress bar 412 using the same or similar techniques described above with respect to enlarged progress bar 406 of FIGS. 5A and 5B to search the multimedia file being executed.

Accordingly, the user may precisely move the execution point of the multimedia file and easily move the execution point by a short section through the enlarged progress bar provided in the expansive search mode.

Also, the user may conveniently move a execution point for a large-size multimedia file by a desired amount and activate the use of a function, such as a video editing. Further, the inconvenience and difficulty experienced by a user of a mobile device (having physical limitations) for performing a search of a multimedia file being executed by said mobile device is reduced thereby making it more plausible to make and use mobile devices for such a purpose.

Yet, further because the present invention provides the expansive search function based on the detection of a long contact with a conventional progress bar being displayed on a conventional touch screen, already existing conventional media players can be modified (by adding the expansive search mode) to operate in accordance with the present invention without having to effect any pre-existing function of the progress bar.

Specific embodiments of the present invention having been shown and described hereinabove, it will be readily understood that various modifications of these embodiments may be made and/or variations of these embodiments that fall within the scope of the present invention may also exist and that the present invention is not limited to the particular embodiments described herein. For example, the discussed embodiment of the present invention employs an example in which the enlarged progress bar is shown overlapping the progress bar. It will be readily understood that the enlarged progress bar may be displayed such that it does not overlap the original progress bar. The enlarged progress bar may, for example, completely hide the original progress bar or hide the progress bar that was being displayed. Another example is that the enlarged progress bar can be displayed on a totally different screen or touch screen and not necessarily on the touch screen of the multimedia device that is performing the expansive search function. Further, the particular embodiments of the present invention described above uses an example in which the progress bar is enlarged in two stages. It will be readily understood that the present invention includes embodiments where the progress bar may be enlarged in more than two stages. Further, the present invention is described in terms of the media player entering the expansive search mode due to the detection of a long contact with the progress bar. Such an implementation is one example of how the multimedia file executing device may enter into the expansive search mode. Other implementations exist where the media player may enter the expansive search mode through a separate menu item or an icon. Another alternative is where the media player may enter the expansive search mode when the long contact with any point on the multimedia player screen is detected

It would be appreciated that the embodiments of the present invention may be embodied in software or hardware and a combination of hardware and software. The software may be stored in a volatile or non-volatile storage device including a ROM, a memory including a RAM, a memory chip, a device, and an integrated circuit, or optical or magnetically recordable and simultaneously machine-readable storage medium including a CD, a DVD, a magnetic disk, or a magnetic tape, regardless of an any erasable function or a rewritable functions. Accordingly, the present invention includes a program comprising codes for implementing the apparatus or the method defined in any claim of the present specification and a machine (computer, etc.) readable storage media for storing the program. Further, the program may be electronically transferred through a predetermined media, such as a communication signal transferred through wired or wireless connection.

In the circumstance where the multimedia executing apparatus or device is a mobile device, the mobile device may use a program (e.g. an application) for the multimedia expansive search in accordance with an embodiment of the present invention by downloading the program from a program providing apparatus (e.g. a server) located at a remote site. That is, when the program for the multimedia expansive search function is installed in the mobile device, it may be executed in the mobile device and provide the multimedia expansive search function. The program providing apparatus transmits the program to the mobile device automatically or in a response to a program transmission request from the mobile device. In such a case, the program providing apparatus may additionally determine whether the mobile device is a subscriber to a service being provided by the program providing apparatus and thus the apparatus may perform user authentication, and payment confirmation with respect to the mobile device. The program providing apparatus may include a communication unit for wired or wireless communication with the mobile device, a storage medium for storing the program, and a controller for transmitting the program to the mobile device through the communication unit. The storage medium may be within the program providing apparatus or may be located outside of the program providing apparatus.

Therefore, the scope of the present invention shall not be limited to the described embodiments and is defined by any embodiment that fall within the claimed method and apparatus of the present invention.

What is claimed is:

1. A method of expansively searching multimedia in a multimedia executing apparatus, the method comprising:
displaying a progress bar indicating an execution point for execution of a multimedia file on a screen; and
displaying an enlarged progress bar comprising an enlarged section of the progress bar including the execution point on the screen when the multimedia executing apparatus is caused to enter into an expansive search mode.

2. The method as claimed in claim 1, further comprising causing the multimedia executing apparatus to enter into the expansive search mode when a contact greater than a predetermined duration with the progress bar is detected.

3. The method as claimed in claim 2, further comprising enlarging a section of the enlarged progress bar having the execution point and displaying the enlarged section on the screen, when a contact greater than the predetermined duration with the enlarged progress bar is detected after the multimedia executing apparatus is caused to enter the expansive search mode.

4. The method as claimed in claim 1, wherein the enlarged progress bar is displayed as partially overlapping on the progress bar.

5. The method as claimed in claim 1, further comprising:
moving the execution point to a location corresponding to a position of a contact with the enlarged progress bar when the contact with the enlarged progress bar is detected; and
executing the multimedia file from the moved execution point.

6. The method as claimed in claim 5, wherein moving of the execution point comprises moving the execution point such that an interval between the execution point and the point of the contact corresponds to a reduced interval according to an enlargement ratio of the enlarged progress bar with respect to the progress bar.

7. A multimedia executing apparatus comprising:
a touch screen for displaying a progress bar indicating an execution point for execution of a multimedia file; and
a controller for displaying an enlarged progress bar representing an enlarged section of the progress bar including the execution point on the screen when the multimedia executing apparatus is caused to enter into an expansive search mode.

8. The multimedia executing apparatus as claimed in claim 7, wherein the controller causes the multimedia executing apparatus to enter the expansive search mode when a contact greater than a predetermined duration with the progress bar is detected.

9. The multimedia executing apparatus as claimed in claim 8, wherein the controller enlarges a section of the enlarged progress bar including the execution point and displays the enlarged section on the screen, when a contact greater than the predetermined duration with the enlarged progress bar is detected after the multimedia executing apparatus has entered into the expansive search mode.

10. The multimedia executing apparatus as claimed in claim 7, wherein the controller displays the enlarged progress bar such that the enlarged progress bar partially overlaps the progress bar.

11. The multimedia executing apparatus as claimed in claim 7, wherein the controller moves the execution point of the enlarged progress bar to a point corresponding to a position of a contact and executes the multimedia file from the moved execution point, when the contact with the enlarged progress bar is detected.

12. The multimedia executing apparatus as claimed in claim 11, wherein the controller moves the execution point such that an interval between the execution point and the point of the contact corresponds to a reduced interval according to an enlargement ratio of the enlarged progress bar.
